(19) United States
(12) Patent Application Publication
(10) Pub. No.: US 2012/0117450 A1
(43) Pub. Date: May 10, 2012

(54) DISPLAY APPARATUS, REMOTE CONTROLLER AND CONTROL METHOD THEREOF

(75) Inventors: Dong-keun NAM, Seongnam-si (KR); Jae-hwang LEE, Seoul (KR); Seung-han GO, Yongin-si (KR)

(73) Assignee: SAMSUNG ELECTRONICS CO., LTD., Suwon-si (KR)

(21) Appl. No.: 13/172,324

(22) Filed: Jun. 29, 2011

(30) Foreign Application Priority Data
Nov. 10, 2010 (KR) 10-2010-0111418

(51) Int. Cl. G06F 17/00; G06F 3/048

(52) U.S. Cl. 715/205

(57) ABSTRACT

A display apparatus, a remote controller and a control method thereof, the display apparatus including a first communication section which receives web page data including a plurality of link items, a receiving section which receives a video signal, a signal processing section which processes the web page data or the video signal, a display section which displays a web page corresponding to the processed web page data or a video corresponding to the processed video signal, and a control section which groups the plurality of link items included in the displayed web page into a predetermined number of groups, generates index information about the groups and the link items included in the groups, and displays first user selection icons corresponding to each group using the generated index information.

### CROSS-REFERENCE TO RELATED PATENT APPLICATION

This application claims priority from Korean Patent Application No. 10-2010-0111418, filed on Nov. 10, 2010, in the Korean Intellectual Property Office, the disclosure of which is incorporated herein in its entirety by reference.

### BACKGROUND

1. Field

Apparatuses and methods consistent with exemplary embodiments relate to a display apparatus, a remote controller and a control method thereof, and more particularly, to a display apparatus, a remote controller and a control method thereof which allow a user to easily select a link item on a web page displayed on the display apparatus and which enhance readability of the displayed web page.

2. Description of the Related Art

An Internet Protocol Television (IPTV) or Smart Television (TV) which provide digital television services to a user using an Internet protocol on a broadband connection has become widespread in recent years. The IPTV provides Internet services in addition to general television functions. However, the IPTV has a limitation in that a user must select items on a web page displayed on the IPTV using a remote controller associated with the IPTV, rather than a pointing device used with a general PC.

In the related art, a symbol is displayed corresponding to every link item included in a web page displayed on the IPTV, and a user selects a desired symbol using a remote controller. However, the web page may include tens or hundreds of link items. In this case, if tens or hundreds of symbols corresponding thereto must be displayed on a screen of the IPTV, readability of the web page may be severely deteriorated. Furthermore, the user must select a desired symbol among the tens or hundreds of symbols using the remote controller, which causes significant inconvenience to the user.

### SUMMARY

Accordingly, it is an aspect of exemplary embodiments to provide a display apparatus, a remote controller and a control method thereof which allow a user to easily select items on a web page while enhancing readability of the web page.

According to an exemplary embodiment, the foregoing and/or other aspects may be achieved by providing a display apparatus including a first communication section which receives web page data including a plurality of link items, a receiving section which receives a video signal, a signal processing section which processes at least one of the web page data or the video signal, a display section which displays at least one of a web page corresponding to the processed web page data or a video corresponding to the processed video signal, and a control section which groups the plurality of link items included in the displayed web page into a predetermined number of groups, generates index information about the groups and the link items included in the groups, and displays first user selection icons corresponding to each group using the generated index information.

The display apparatus may further include a second communication section which communicates with a remote controller which controls the display apparatus, and when one of the first user selection icons is selected through the second communication section, the control section displays second user selection icons for the link items included in the group corresponding to the selected first user selection icon using the index information.

The control section may include an information extracting section which extracts information about frames and the link items from the received web page data.

The control section may further include an index information generating section which groups the plurality of link items into a predetermined number of groups using the extracted information about the link items and generates index information about the groups and the link items included in each group.

The index information generating section may group the plurality of link items using the extracted information about the frames and the link items and may generate index information about the link items included in each frame.

The index information generating section may combine a frame that only includes one link item with a frame that includes at least two link items and generate index information about the link items included in the combined frames.

The control section may control the second communication section to transmit the generated index information to the remote controller.

The foregoing and/or other aspects may be achieved by providing a remote controller including a communication section which communicates with a display apparatus, a signal processing section which processes a video signal, a display section which displays a video corresponding to the processed video signal, a user input section through which a user selection is inputted, and a control section which uses index information to display on the display section first user selection icons corresponding to groups obtained by grouping a plurality of link items included in a web page displayed on the display apparatus into a predetermined number of groups, when the index information about the groups and the link items included in each group is received from the display apparatus through the communication section.

When one of the first user selection icons is selected through the user input section, the controller may control the communication section to transmit the selection to the display apparatus, and may control the display section to display second user selection icons for the link items included in the group corresponding to the selected first user selection icon using the received index information.

The foregoing and/or other aspects may be achieved by providing a control method of a display apparatus, including receiving web page data including a plurality of link items, processing the received web page data to display a web page, grouping the plurality of link items included in the displayed web page into a predetermined number of groups and generating index information about the groups and the link items included in the groups, and displaying first user selection icons corresponding to each group using the generated index information.

The method may further include, when one of the first user selection icons is selected, displaying second user selection icons for the link items included in the group corresponding to the selected first user selection icon using the index information.

The method may further include extracting information about frames and the link items from the received web page data.

The generating index information may include grouping the plurality of link items using the extracted information about the frames and the link items and generating index information about the link items included in each frame.

The method may further include transmitting the generated index information to a remote controller which controls the display apparatus.

The foregoing and/or other aspects may be achieved by providing a control method of a remote controller which controls a display apparatus and comprises a display section, including receiving index information about groups obtained by grouping a plurality of link items included in a web page displayed on the display apparatus into a predetermined number of groups and the link items included in each group, from the display apparatus, and displaying first user selection icons corresponding to each group on the display section using the received index information.

The method may further include, when one of the first user selection icons is selected, transmitting the selection to the display apparatus, and displaying second user selection icons corresponding to the link items included in the group corresponding to the selected first user selection icon on the display section using the received index information.

According to exemplary embodiments, there is provided a display apparatus, a remote controller and a control method thereof which allow a user to easily select items on a web page while enhancing readability of the web page.

### BRIEF DESCRIPTION OF THE DRAWINGS

The above and other aspects will become apparent and more readily appreciated from the following description of exemplary embodiments, taken in conjunction with the accompanying drawings, in which:

FIG. 1 is a control block diagram illustrating a display apparatus according to an exemplary embodiment;

FIG. 2 is a control block diagram illustrating a remote controller according to an exemplary embodiment;

FIGS. 3A, 3B and 3C are diagrams illustrating a process of generating index information by a control section of a display apparatus;

FIG. 4A is a diagram illustrating an example in which index information about groups is displayed in a remote controller according to an exemplary embodiment;

FIG. 4B is a diagram illustrating an example in which index information about link items included in a group in FIG. 4A is displayed;

FIG. 5 is a control flow diagram of a display apparatus according to an exemplary embodiment; and

FIG. 6 is a control flow diagram of a remote controller according to an exemplary embodiment.

### DETAILED DESCRIPTION OF EXEMPLARY EMBODIMENTS

Below, exemplary embodiments will be described in detail with reference to the accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

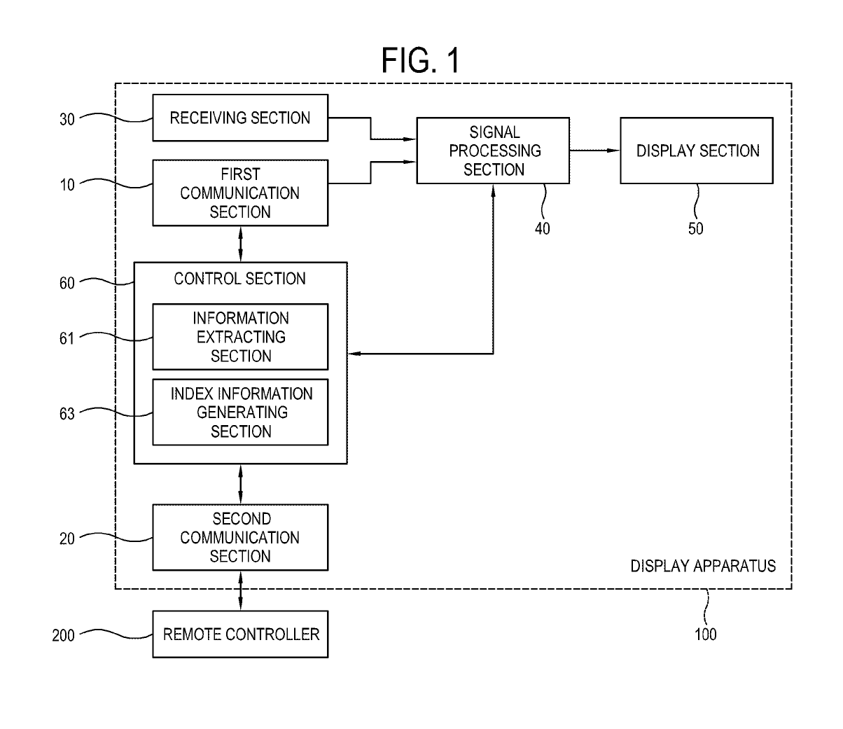

FIG. 1 is a control block diagram illustrating a display apparatus 100 according to an exemplary embodiment.

As shown in FIG. 1, the display apparatus 100 includes a first communication section 10, a second communication section 20, a receiving section 30, a signal processing section 40, a display section 50 and a control section 60 which controls these components.

The first communication section 10 receives web page data including a plurality of link items from the outside. The first communication section 10 may receive the web page data from an external server through a network. General Internet services may be provided through the first communication section 10. Thus, the display apparatus 100 according to this embodiment includes an IPTV based on the Internet protocol.

The first communication section 10 may communicate with the external server through network communication such as LAN, WLAN or the like.

The second communication section 20 may communicate with a remote controller 200 which controls the display apparatus 100 to transmit and receive a variety of control signals and data. The second communication section 20 may receive a user selection for controlling the display apparatus 100 from the remote controller 200. Furthermore, the second communication section 20 may transmit index information about groups obtained by grouping a plurality of link items into a predetermined number of groups under the control of the control section 60 and index information about link items included in each group, to the remote controller 200.

The second communication section 20 may communicate with the remote controller 200 through wireless communication such as WLAN, RF, ZigBee or Bluetooth.

The receiving section 30 receives a video signal from an external video source (not shown). The video source may include a computer which generates a video signal using a CPU and a graphic card which provides the video signal to the outside, a server which transmits a video signal over a network, a transmitter of a broadcasting station which transmits a video signal using airwaves or cables, or the like. The receiving section 30 receives the video signal from the outside and delivers the video signal to the signal processing section 40. The receiving section 30 may be implemented in various manners according to the standard of the received video signal and the type of the display apparatus 100.

For example, if the display apparatus 100 is realized as a television, the receiving section 30 may receive a radio frequency (RF) signal transmitted from a video receiving device in a wireless manner, or may receive a video signal according to a variety of standards such as composite video, component video, super video, SCART or High Definition Multimedia Interface (HDMI). In this respect, the receiving section 30 may further include an antenna (not shown) and/or a tuner (not shown) which tunes a video channel.

The signal processing section 40 processes the web page data received through the first communication section 10 and/or the video signal received through the receiving section 30 so that a web page corresponding to the processed web page data and/or a video corresponding to the processed video signal is displayed on the display section 50.

The signal processing section 40 performs a variety of processes for processing the video signal. For example, the processes may include decoding and encoding corresponding to a variety of video formats, de-interlacing, frame refresh rate conversion, scaling, noise reduction for video quality improvement, detail enhancement, line scanning, and the like. The signal processing section 40 may perform the processes in an individual or composite manner.

The signal processing section 40 may process an audio signal received together with the video signal through the receiving section 30. Thus, the signal processing section 40 may perform a variety of processes for processing the audio signal. For example, the processes may include digital conversion of an analog audio signal, audio signal amplification, audio signal output level adjustment, audio signal frequency adjustment, and the like. The signal processing section 40 may perform the processes in an individual or composite manner. Further, the signal processing section 40 may generate a specific audio signal. In this respect, the display apparatus 100 according to this embodiment may further include a speaker (not shown) which outputs audio corresponding to the audio signal processed by the signal processing section 40. The speaker may include a woofer speaker.

The display section 50 displays a web page corresponding to the web page data processed by the signal processing section 40 or a video corresponding to the video signal processed by the signal processing section 40. The display section 50 may display a video frame obtained by vertically arranging a plurality of horizontal scanning lines scanned from the signal processing section 40. The display section 50 includes a display panel (not shown) which displays the video. The display panel may include an LCD panel, an OLED panel, a PDP panel, or the like. The display section 50 may further include a panel driving section (not shown) which drives the display panel.

The control section 60 groups a plurality of link items included in the web page displayed on the display section 50 into a predetermined number of groups and generates index information about the groups and index information about link items included in each group, and displays a user selection icon corresponding to each group on the basis of the index information. The icon may include one or more of a variety of symbols such as numerals, characters or signs.

The control section 60 may include an information extracting section 61 and an index information generating section 63.

The information extracting section 61 extracts information about frames and/or link items included in a web page currently displayed on the display section 50. Specifically, the information extracting section 61 may extract the information about the frames and/or the link items by detecting frames and/or link tags from source information about the currently displayed web page, for example, HTML data.

The index information generating section 63 generates index information from the information about the frames and/or the link items extracted by the information extracting section 61.

Specifically, the index information generating section 63 may group the plurality of link items included in the web page into a predetermined number of groups on the basis of the information about the link items extracted by the information extracting section 61. Each group includes at least two link items. According to an exemplary embodiment, the plurality of link items may be grouped into one to nine groups, which are numbered so as to correspond to numeral keys in a physical key input section provided in the remote controller, which makes it possible for a user to select a desired group.

The index information generating section 63 may group the plurality of link items included in the web page in the unit of the extracted frame, on the basis of the information about the frames and/or the link items extracted by the information extracting section 61.

In a case where a specific frame does not include any link item but includes text information only or a single link item, the index information generating section 63 may perform the grouping process by combining the specific frame with a different frame.

Further, the index information generating section 63 may perform the grouping process by combining two or more frames, at least one of which includes at least two link items, so as to achieve a suitable number of groups.

The index information generating section 63 generates index information about each group and the link items included in each group, after the grouping process.

The control section 60 controls the display section 50 to display a user selection icon corresponding to each group on the basis of the index information generated by the index information generating section 63.

Further, if a user selection for any one of the displayed group icons is received from the remote controller 200 through the second communication section 20, the control section 60 controls the display section 50 to display icons corresponding to link items included in the group corresponding to the selected group icon. Again, if any one of the displayed link item icons is selected, the control section 60 controls the display section 50 to display a web page corresponding to the selected link item icon.

The control section 60 may control the second communication section 20 to transmit the index information generated by the index information generating section 63 to the remote controller 200.

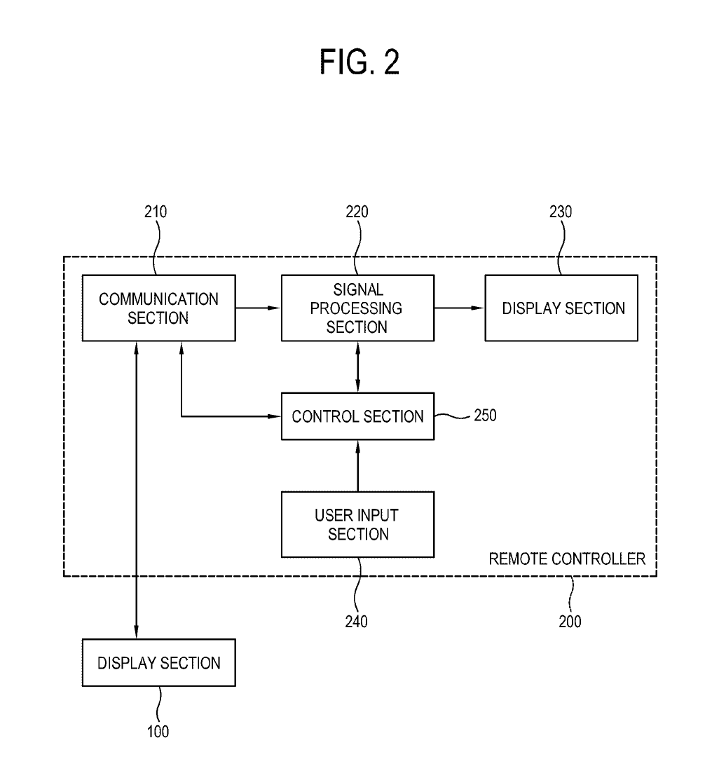

FIG. 2 is a control block diagram illustrating a remote controller 200 according to an exemplary embodiment.

As shown in FIG. 2, the remote controller 200 includes a communication section 210, a signal processing section 220, a display section 230, a user input section 240, and a control section 250 which controls these components.

The communication section 210 may communicate with the second communication section 20 of the display apparatus 100 to transmit and receive a variety of control signals and data. The remote controller 200 may transmit a control signal corresponding to a user selection inputted through the user input section 240 to the display apparatus 100 through the communication section 210. Furthermore, the remote controller 200 may receive the index information about the groups obtained by grouping the plurality of link items included in the web page displayed on the display apparatus 100 into a predetermined number of groups and the index information about the link items included in each group, from the display apparatus 100. The communication section 210 may communicate with the second communication section 20 of the display apparatus 100 through wireless communication such as WLAN, RF, ZigBee or Bluetooth.

The signal processing section 220 may process a specific video signal and transmit the processed video signal to the display section 230. The specific video signal may include a video signal corresponding to a video displayed on the display apparatus 100, which may be received from the display apparatus 100 through the communication section 210. Alternatively, the specific video signal may include a Graphic User Interface (GUI) through which a user selection is inputted. In this case, the signal processing section 220 may generate the GUI.

The signal processing section 220 may perform a variety of processes for the video signal, similarly to the signal processing section 40 of the display apparatus 100.

The display section 230 may display a video corresponding to the video signal processed by the signal processing section 220. The display section 230 includes a display panel (not shown) which displays a video, such as an LCD panel, an OLED panel or a PDP panel. The display section 230 may further include a panel driving section (not shown) which drives the display panel.

The user input section 240 receives an input of a user selection. The user input section 240 may include a plurality of physical function keys such as arrow keys, volume keys, character keys and numeral keys, or may include a touch screen provided in the display section 230.

When index information about a group including link items and the link items included in each group is received from the display apparatus 100, the control section 250 controls the display section 230 to display a user selection icon corresponding to each group on the basis of the received index information.

When a user selects a specific icon displayed on the display section 230 through the user input section 240, the control section 250 controls the communication section 210 to transmit the user selection to the display apparatus 100, and controls the display section 230 to display user selection icons corresponding to link items included in the group corresponding to the selected specific icon on the basis of the received index information.

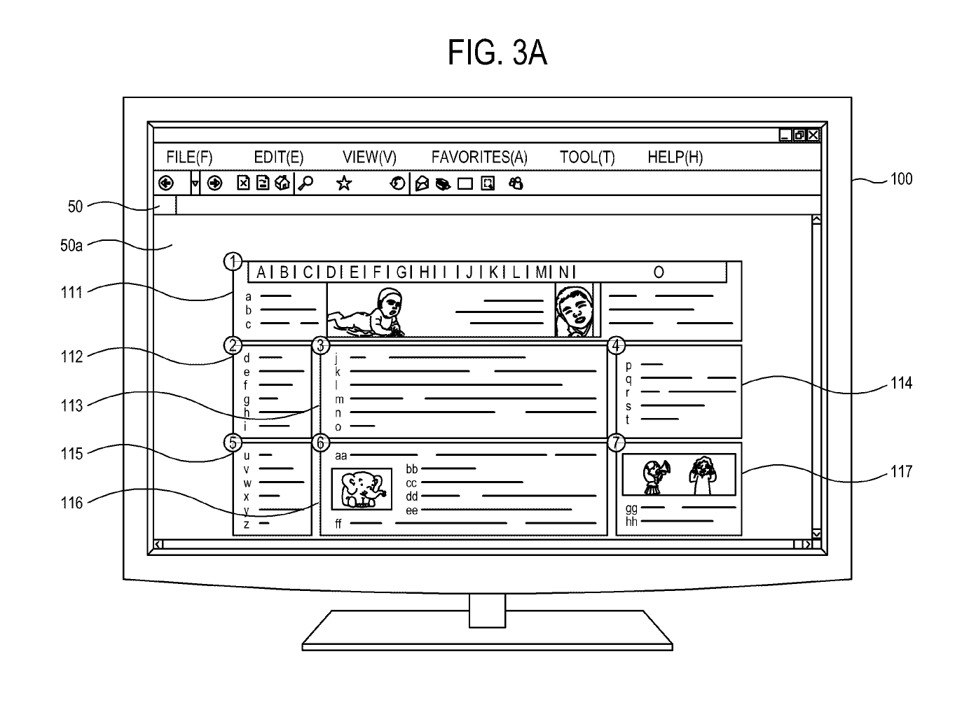

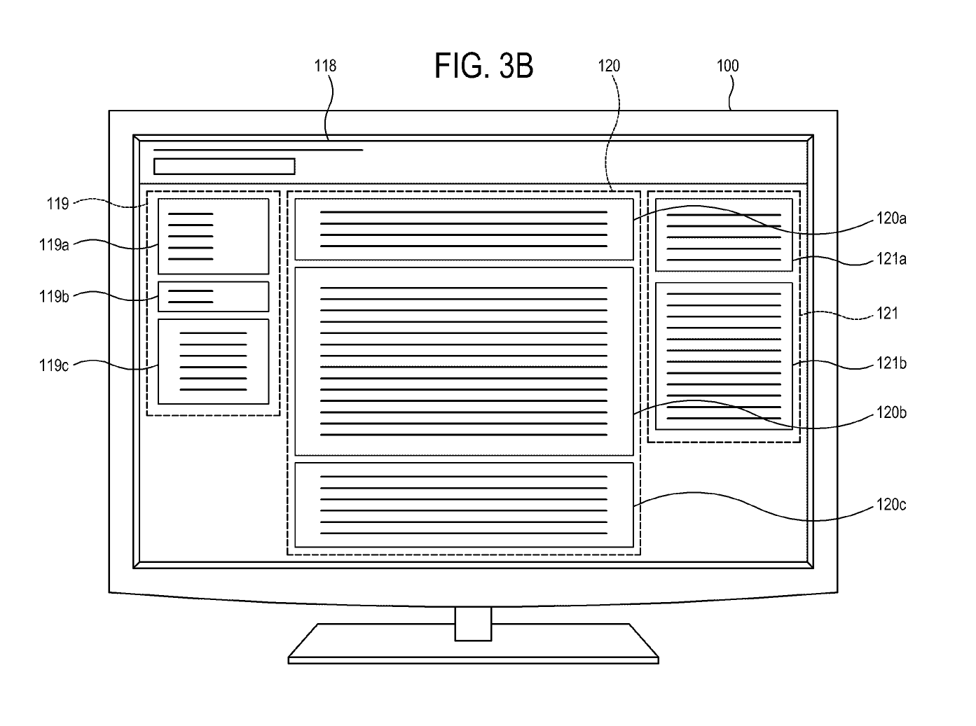

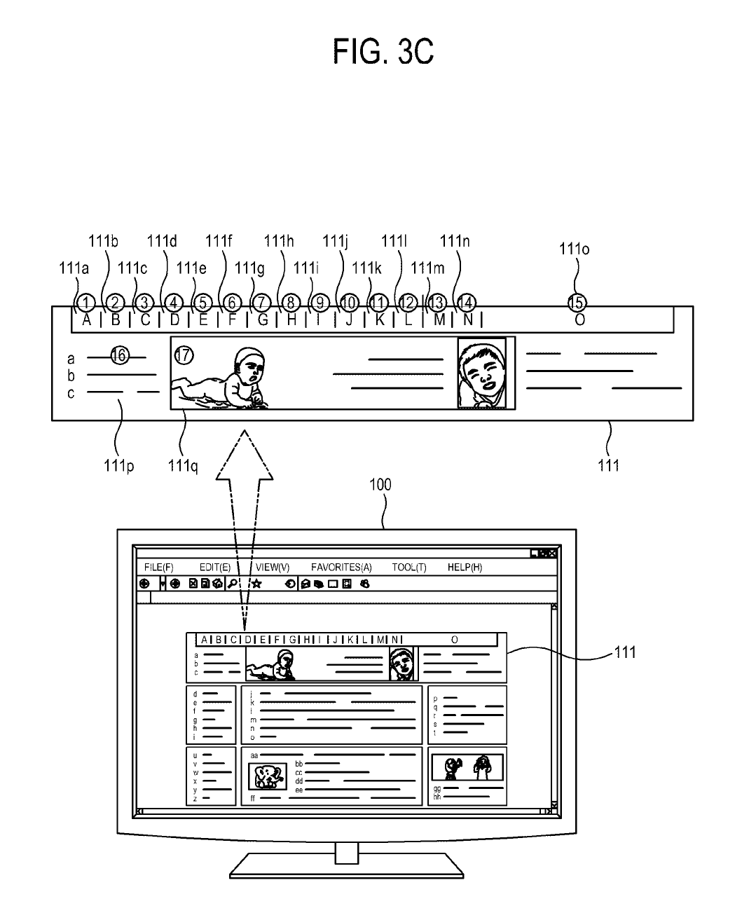

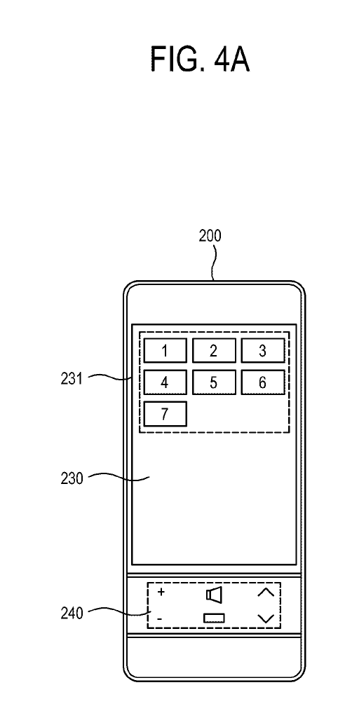

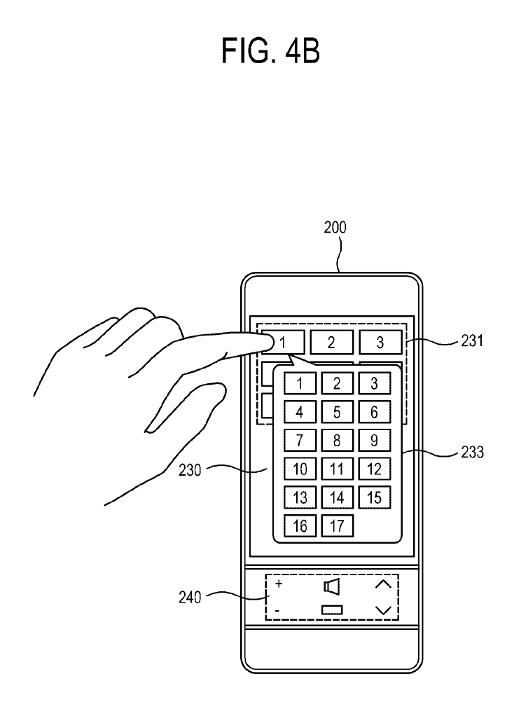

Hereinafter, an exemplary embodiment will be described in more detail with reference to FIGS. 3A, 3B, 3C, and 4.

FIGS. 3A, 3B, and 3C illustrate an example in which index information is generated by the control section 60 of the display apparatus 100.

Here, FIG. 3A illustrates a first example of the index information generation. In this example, a plurality of link items is grouped according to frames to generate the index information.

The display apparatus 100 receives web page data including a plurality of link items through the first communication section 10, and processes the web page data to display a web page 50a on the display section 50.

The information extracting section 61 extracts information about frames and/or the link items from the displayed web page data (for example, HTML data).

The index information generating section 63 groups the plurality of link items according to frames using the information about the frames and/or the link items extracted by the information extracting section 61, and generates index information about each group and the link items included in each group.
Since the currently displayed web page 50a includes seven frames, the link items may be grouped into seven groups according to the number of the frames, and numeral icons 1 to 7 for user selection corresponding to the respective groups are generated and displayed on the display section 50 corresponding to positions of the respective groups 111 to 117.

FIG. 3B illustrates a second example of the index information generation. In the second example, a plurality of frames is combined with each other to group the plurality of link items, to thereby generate index information.

The information extracting section 61 extracts information about frames and/or link items from a currently displayed web page. As shown in FIG. 3B, information about nine frames 118, 119a, 119b, 119c, 120a, 120b, 120c, 121a, 121b is extracted.

In this example, each of the frames 119b and 120a includes a single link item. In this case, if the frames 119b and 120a are divided into individual groups, a user must select a desired link item through at least two stages, which may cause inconvenience. In other words, a user must first select the group which includes the desired link item, and then the user must select the desired link item, even though the group only contains one link item.

Thus, in such a case, the frames 119b and 120a which each include a single link item may be combined with a different frame for grouping, respectively. For example, the frame 119b may be combined with the frames 119a and 119c into a group 119, and the frame 120a may be combined with the frames 120b and 120c into a group 120.

Thus, according to an exemplary embodiment, the plurality of link items are extracted and grouped according to frames on the basis of combining the plurality of frames. Alternatively, according to another exemplary embodiment, the plurality of link items may be grouped into a predetermined number of groups (for example, two to twenty, preferably two to ten) in consideration of the relative position on the web page using the information about the link items extracted by the information extracting section 61, regardless of the frames, to generate index information about each group.

As shown in FIG. 3C, when any one of the groups generated in the first example of the index information generation shown in FIG. 3A is selected, index information about link items included in the selected group is generated.

Referring to FIG. 3A, the currently displayed web page is divided into seven groups 111, 112, 113, 114, 115, 116, 117 according to frames, and the groups are given numeral icons 1 to 7.

If a specific icon, for example, the numeral icon 1, is selected among the numeral icons 1 to 7 corresponding to the groups 111, 112, 113, 114, 115, 116, 117 through the remote controller, index information about link items 111a, 111b, 111c, 111d, 111e, 111f, 111g, 111h, 111i, 111j, 111k, 111l, 111m, 111n, 111o, 111p, 111q included in the group 111 corresponding to the selected numeral icon 1 is generated, and numeral icons 1 to 17 corresponding to the link items 111a, 111b, 111c, 111d, 111e, 111f, 111g, 111h, 111i, 111j, 111k, 111l, 111m, 111n, 111o, 111p, 111q are generated and displayed. If any one of the numeral icons 1 to 17 for the link items 111a, 111b, 111c, 111d, 111e, 111f, 111g, 111h, 111i, 111j, 111k, 111l, 111m, 111n, 111o, 111p, 111q is selected, a web page corresponding to the selected link item is received and displayed on the display section.

If any one of the numeral icons 1 to 7 corresponding to the groups 111, 112, 113, 114, 115, 116, 117 is selected, a part of the web page corresponding to the selected numeral icon may be displayed on a separate full screen, or may be displayed overlapping all or a portion of the current web page 50a. Alternatively, icons corresponding to the link items may be directly displayed in a region of the current web page 50a corresponding to the selected numeral icon corresponding to the groups.

FIG. 4A illustrates an example in which group index information is displayed in the remote controller 200 according to an exemplary embodiment.

The remote controller 200 receives index information about a web page displayed on the display apparatus 100 from the display apparatus 100 through the communication section 210. The index information is generated by the index information generating section 63 of the display apparatus 100, and is index information about a group obtained by grouping a plurality of link items according to frames using information about frames and/or link items extracted by the information extracting section 61 and index information about link items included in each group.

The remote controller 200 generates an icon corresponding to the received index information and displays the icon on the display section 230.

To this end, the remote controller 200 firstly generates, from the received index information, icons 231 corresponding to index information about groups obtained by grouping a plurality of link items included in a web page displayed on the display apparatus 100 into a predetermined number of groups, and displays the icons 231 on the display section 230.

The icons are preferably identical to the icons corresponding to the groups displayed on the display apparatus 100. For example, if the numeral icons 1 to 7 corresponding to the groups 111, 112, 113, 114, 115, 116, 117 are displayed on the display apparatus 100 as shown in FIG. 3A, the numeral icons 1 to 7 which are user selection icons, corresponding to the groups, may be displayed on the display section 230 of the remote controller 200.

FIG. 4B illustrates an example in which index information about link items included in the group in FIG. 4A is displayed.

If any one of the numeral icons 1 to 7 corresponding to the groups displayed in FIG. 4A is selected by a user, the remote controller 200 transmits a control signal corresponding to the user selection to the display apparatus 100.

If a user selects the numeral icon 1 among the numeral icons 1 to 7 corresponding to the groups in FIG. 4A (see also FIG. 3A), the remote controller 200 transmits a control signal corresponding to the numeral icon 1 to the display apparatus 100.

Then, the display apparatus receives the control signal and displays the numeral icons 1 to 17 for the link items 111a, 111b, 111c, 111d, 111e, 111f, 111g, 111h, 111i, 111j, 111k, 111l, 111m, 111n, 111o, 111p, 111q included in the group 111 corresponding to the numeral icon 1 on the display section 50.

Furthermore, the remote controller 200 displays the numeral icons 1 to 17 corresponding to the link items included in the group 111 corresponding to the numeral icon 1 on the display section 230. If any one of the displayed numeral icons 1 to 17 corresponding to the link items is selected by the user, the remote controller 200 transmits a control signal corresponding to the selected numeral icon for link item to the display apparatus 100. The display apparatus 100 receives a web page in a link corresponding to the selected numeral icon and displays the web page on the display section 50.

The remote controller 200 may display the icons 231 for the group indexes and icons 233 for the link items included in the selected group on a separate screen, or may display the icons 231 and 233 in an overlapped manner as shown in FIG. 4B.

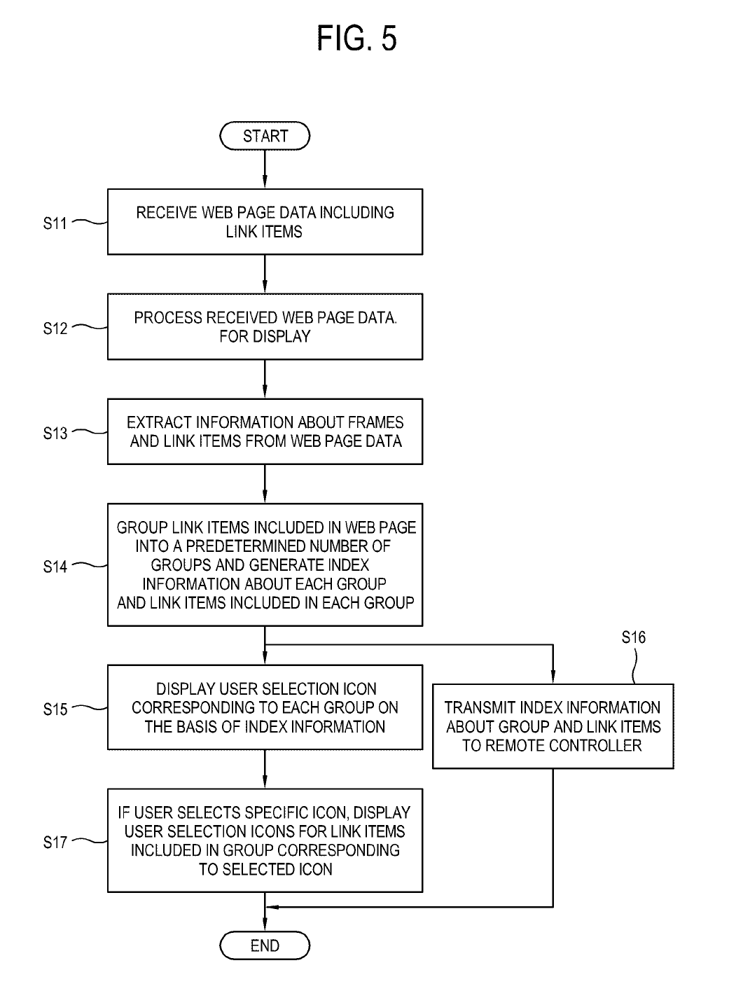

FIG. 5 is a control flow diagram of a display apparatus according to an exemplary embodiment.

If the display apparatus 100 receives web page data including a plurality of link items from the outside through the first communication section 10 (S11), the signal processing section 40 processes the received web page data and displays a web page on the display section 50 (S12). The information extracting section 61 extracts information about frames and link items from the web page data (S13), and then, the index information generating section 63 groups the plurality of link items included in the displayed web page into a predetermined number of groups on the basis of the extracted information and generates index information about each group and link items included in each group (S14). The generated index information about the group and the link items is transmitted to the remote controller 200 (S16). Then, the remote controller 200 generates a user selection icon corresponding to the generated group index information and displays the icon in a position corresponding to each group (S15). If a user selects a specific icon, the remote controller 200 displays user selection icons for link items included in the group corresponding to the selected icon for group on the basis of the index information (S17).

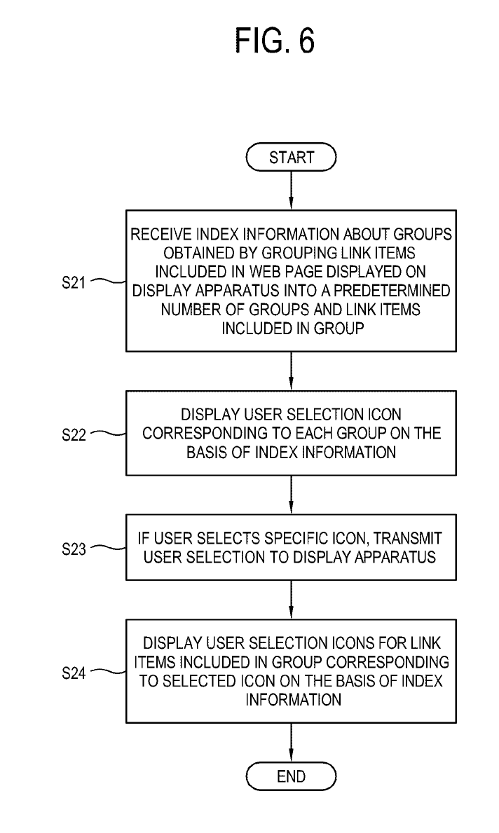

FIG. 6 is a control flow diagram of a remote controller according to an exemplary embodiment.

If the remote controller 200 receives the index information about the groups and the link items (S21), the remote controller 200 displays a user selection icon corresponding to each group on the basis of the received group index information on the display section 230 (S22).

If a user selects a specific icon through the user input section 240, the remote controller 200 transmits the inputted user selection to the display apparatus 100 (S23). Furthermore, the remote controller 200 displays user selection icons for link items included in the group corresponding to the selected group icon on the display section 230, on the basis of the received index information about the link items (S24). Then, if the user selects any one of the icons corresponding to the link items, the remote controller 200 transmits the user selection to the display apparatus 100.

Although exemplary embodiments have been shown and described, it will be appreciated by those skilled in the art that changes may be made to these exemplary embodiments without departing from the principles and spirit of the invention, the scope of which is defined in the appended claims and their equivalents.

What is claimed is:

1. A display apparatus comprising:
a first communication section which receives web page data including a plurality of link items;
a receiving section which receives a video signal;
a signal processing section which processes at least one of the web page data or the video signal;
a display section which displays at least one of a web page corresponding to the processed web page data or a video corresponding to the processed video signal; and
a control section which groups the plurality of link items included in the displayed web page into a predetermined number of groups, generates index information about the groups and the link items included in the groups, and displays first user selection icons corresponding to each group using the generated index information.

2. The display apparatus according to claim 1, further comprising a second communication section which communicates with a remote controller which controls the display apparatus,
wherein when one of the first user selection icons is selected through the second communication section, the control section displays second user selection icons for the link items included in the group corresponding to the selected first user selection icon using the index information.

3. The display apparatus according to claim 2, wherein the control section comprises an information extracting section which extracts information about frames and the link items from the received web page data.

4. The display apparatus according to claim 3, wherein the control section further comprises an index information generating section which groups the plurality of link items into a predetermined number of groups using the extracted information about the link items and generates index information about the groups and the link items included in each group.

5. The display apparatus according to claim 4, wherein the index information generating section groups the plurality of link items using the extracted information about the frames and the link items and generates index information about the link items included in each frame.

6. The display apparatus according to claim 4, wherein the index information generating section combines a frame that only includes one link item with a frame that includes at least two link items and generates index information about the link items included in the combined frames.

7. The display apparatus according to claim 4, wherein the control section controls the second communication section to transmit the generated index information to the remote controller.

8. A remote controller comprising:
a communication section which communicates with a display apparatus;
a signal processing section which processes a video signal;
a display section which displays a video corresponding to the processed video signal;
a user input section through which a user selection is inputted; and
a control section which uses index information to display on the display section first user selection icons corresponding to groups obtained by grouping a plurality of link items included in a web page displayed on the display apparatus into a predetermined number of groups, when the index information about the groups and the link items included in each group is received from the display apparatus through the communication section.

9. The remote controller according to claim 8, wherein when one of the first user selection icons is selected through the user input section, the controller controls the communication section to transmit the selection to the display apparatus, and controls the display section to display second user selection icons for the link items included in the group corresponding to the selected first user selection icon using the received index information.

10. A control method of a display apparatus, comprising:
receiving web page data including a plurality of link items;
processing the received web page data to display a web page;
grouping the plurality of link items included in the displayed web page into a predetermined number of groups and generating index information about the groups and the link items included in the groups; and
displaying first user selection icons corresponding to each group using the generated index information.

11. The method according to claim 10, further comprising:
when one of the first user selection icons is selected, displaying second user selection icons for the link items included in the group corresponding to the selected first user selection icon using the index information.

12. The method according to claim 11, further comprising extracting information about frames and the link items from the received web page data.

13. The method according to claim 12, wherein the generating index information comprises grouping the plurality of link items using the extracted information about the frames and the link items and generating index information about the link items included in each frame.

14. The method according to claim 13, further comprising transmitting the generated index information to a remote controller which controls the display apparatus.

15. A control method of a remote controller which controls a display apparatus and comprises a display section, comprising:
receiving index information about groups obtained by grouping a plurality of link items included in a web page displayed on the display apparatus into a predetermined number of groups and the link items included in each group, from the display apparatus; and
displaying first user selection icons corresponding to each group on the display section using the received index information.

16. The method according to claim 15, further comprising:
when one of the first user selection icons is selected, transmitting the selection to the display apparatus; and
displaying second user selection icons corresponding to the link items included in the group corresponding to the selected first user selection icon on the display section using the received index information.
